(19) United States
(12) Patent Application Publication
(10) Pub. No.: US 2020/0166752 A1
(43) Pub. Date: May 28, 2020

(54) DISPLAY FOR USE IN DISPLAY APPARATUS

(71) Applicant: Varjo Technologies Oy, Helsinki (FI)

(72) Inventors: Urho Konttori, Helsinki (FI); Oiva Arvo Oskari Sahlsten, Salo (FI); Klaus Melakari, Oulu (FI)

(21) Appl. No.: 16/200,020

(22) Filed: Nov. 26, 2018

(51) Int. Cl. G02B 27/01; G02B 27/10; G02B 27/02

(52) U.S. Cl. CPC G02B 27/0172; G02B 27/1066; G02B 2027/0138; G02B 2027/0147; G02B 2027/0187; G02B 27/027

(57) ABSTRACT

A display for use in a display apparatus. The display includes a first display part having a first display resolution, and a second display part having a second display resolution, the second display resolution being higher than the first display resolution, the first display part and the second display part being arranged in a manner that a display area of the second display part is substantially surrounded by a display area of the first display part.

### TECHNICAL FIELD

The present disclosure relates generally to representation of visual information and more specifically, to displays comprising first display parts and second display parts. Furthermore, the present disclosure also relates to display apparatuses comprising the aforesaid displays and processors.

### BACKGROUND

Nowadays, several technologies are being used to present interactive simulated environments to users of specialized devices. Such technologies include virtual reality, augmented reality, mixed reality, and the like. Presently, the users utilize the specialized devices (for example, such as virtual reality headsets, a pair of virtual reality glasses, augmented reality headsets, a pair of augmented reality glasses, mixed reality headsets, a pair of mixed reality glasses, and the like) for experiencing and interacting with such simulated environments. Specifically, the simulated environments enhance the user's experience of reality around him/her by providing the user with a feeling of immersion within the simulated environment, using contemporary techniques such as stereoscopy.

Generally, the specialized devices include displays arranged therein, whereupon images of a visual scene within a given simulated environment are rendered. Generally such displays cover an entire viewing angle of the user's eyes. In an example, such devices have two displays for providing different views (for example, such as a left perspective view and a right perspective view) of a given scene within the given simulated environment to the user's eyes. In another example, such devices have a single display whereupon the different views of the given scene are provided on a shared basis. Such different views allow the user to perceive stereoscopic depth within the given scene, thereby, creating the feeling of immersion within the simulated environment.

However, conventional displays associated with such specialized devices have certain limitations associated therewith. Generally, in such specialized devices, a distance between the displays and the user's eyes is very less (of an order of a few millimeters) when the specialized device is worn by the user. In such a case, if low-resolution displays are employed in the specialized devices, the user is able to detect separate pixels of such displays. However, when high-resolution displays having higher pixel density (namely, pixel per unit area) as compared to the low-resolution displays are employed, the manufacturing cost of the displays increases substantially. Consequently, an overall cost of the specialized devices also increases. Furthermore, if the displays are made up of several display parts, the user is able to detect joint boundaries between such display parts. As a result, the images rendered upon such displays appear to be discontinuous due to the visible joint boundaries between display parts. Consequently, the devices employing such displays are unable to provide the feeling of immersion within the simulated environment, to the user.

Therefore, in light of the foregoing discussion, there exists a need to overcome the aforementioned drawbacks associated with conventional displays used in specialized devices for implementing simulated environments.

### SUMMARY

The present disclosure seeks to provide a display for use in a display apparatus.

The present disclosure also seeks to provide a display apparatus.

The present disclosure seeks to provide a solution to the existing problems of resolution and image discontinuities that are associated with conventional displays. An aim of the present disclosure is to provide a solution that overcomes at least partially the problems encountered in prior art, and provides cost-effective, substantially-high resolution displays that eliminate the aforesaid discontinuities associated with rendering of images upon the displays, for providing immersive, simulated environments to users of display apparatuses.

In one aspect, an embodiment of the present disclosure provides a display for use in a display apparatus, the display comprising:

a first display part having a first display resolution; and

a second display part having a second display resolution, the second display resolution being higher than the first display resolution, the first display part and the second display part being arranged in a manner that a display area of the second display part is substantially surrounded by a display area of the first display part.

In another aspect, an embodiment of the present disclosure provides a display apparatus comprising:

a display comprising a first display part and a second display part, the first display part having a first display resolution, the second display part having a second display resolution, the second display resolution being higher than the first display resolution, the first display part and the second display part being arranged in a manner that a display area of the second display part is substantially surrounded by a display area of the first display part; and

a processor coupled to the display, the processor being configured to render a first image and a second image at the first display part and the second display part, respectively and substantially simultaneously.

Embodiments of the present disclosure substantially eliminate or at least partially address the aforementioned problems in the prior art, and enables rendering of substantially continuous images upon the aforesaid display having display parts with different display resolutions.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIGS. 1A and 1B illustrate a front view and a top view of a display for use in a display apparatus respectively, in accordance with an embodiment of the present disclosure;

FIGS. 2A and 2B illustrate a front view and a top view of a first display part of a display respectively, in accordance with an embodiment of the present disclosure;

FIGS. 3A and 3B illustrate a front view and a top view of a second display part of a display respectively, in accordance with an embodiment of the present disclosure;

FIGS. 4A-4G illustrate exemplary implementations of a display, in accordance with various embodiments of the present disclosure;

FIG. 5 is a schematic illustration of an exemplary first optical element and an exemplary second optical element, in accordance with an embodiment of the present disclosure;

FIGS. 6A-6D illustrate exemplary implementations of a first optical piece and a second optical piece in a display, in accordance with various embodiments of the present disclosure;

FIG. 7 is a schematic illustration of an input image displayed at a display, in accordance with an embodiment of the present disclosure; and

FIGS. 8A and 8B illustrate block diagrams of architecture of a display apparatus, in accordance with different embodiments of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a display for use in a display apparatus, the display comprising:

a first display part having a first display resolution; and

a second display part having a second display resolution, the second display resolution being higher than the first display resolution, the first display part and the second display part being arranged in a manner that a display area of the second display part is substantially surrounded by a display area of the first display part.

In another aspect, an embodiment of the present disclosure provides a display apparatus comprising:

a display comprising a first display part and a second display part, the first display part having a first display resolution, the second display part having a second display resolution, the second display resolution being higher than the first display resolution, the first display part and the second display part being arranged in a manner that a display area of the second display part is substantially surrounded by a display area of the first display part; and

a processor coupled to the display, the processor being configured to render a first image and a second image at the first display part and the second display part, respectively and substantially simultaneously.

The present disclosure provides the aforementioned display and the aforementioned display apparatus comprising such a display. The display described herein includes display parts having different display resolutions, such display parts being arranged in a manner that the display allows for mimicking optical properties of the human visual system. Notably, manufacturing costs associated with the aforesaid display are lesser as compared to fully high-resolution displays of the same size. Furthermore, the display allows for the images to be displayed thereupon to appear substantially continuous. In other words, boundaries or gaps between the first and second display parts are imperceptible to a user under normal viewing conditions, thereby, enhancing an appearance of the visual scene.

Throughout the present disclosure, the term “display apparatus” used herein relates to specialized equipment that is configured to display a visual scene of a simulated environment to a user of the display apparatus, when the display apparatus is worn by the user on his/her head. In such an instance, the display apparatus is operable to act as a device (for example, such as a virtual reality headset, an augmented reality headset, a mixed reality headset, a pair of virtual reality glasses, a pair of augmented reality glasses, a pair of mixed reality glasses and so forth) for presenting the simulated environment to the user.

Throughout the present disclosure, the term “display” used herein relates to equipment (for example, such as a display screen) that is configured to facilitate rendering of an input image depicting the visual scene thereupon.

The display comprises the first display part having the first display resolution and the second display part having the second display resolution. Notably, the first display part relates to a portion of the display that allows for rendering the first image. Furthermore, the second display part relates to another portion of the display that allows for rendering the second image.

It will be appreciated that the first and second images collectively constitute the input image depicting the visual scene. Therefore, the first image depicts a first portion of the visual scene whereas the second image depicts a second portion of the visual scene. Optionally, the second image substantially corresponds to a central region of the input image whereas the first image substantially corresponds to a peripheral region of the input image.

The first display part and the second display part are arranged in the manner that the display area of the second display part is substantially surrounded by the display area of the first display part. Notably, the display area of the second display part appears to be surrounded by the display area of the first display part, when viewed by the user. Therefore, the second image displayed on the second display part appears to be surrounded by the first image displayed on the first display part, when viewed by the user. Throughout, the present disclosure, the term “display area” of a given display part relates to a region of the given display part whereupon a given image can be rendered. In other words, the display area of the given display part relates to an actual usable area of the given display part for rendering purposes. The display areas of the first and second display parts include a plurality of pixels that allow for implementing the aforesaid rendering functionality.

Optionally, each of the first display part and the second display part comprises a sealant area, wherein the sealant area is arranged substantially along a periphery of the first display part and a periphery of the second display part, respectively. More optionally, the sealant area of the first display part is arranged substantially along a periphery of the display area of the first display part whereas the sealant area of the second display part is arranged substantially along a periphery of the display area of the second display part. The term “sealant area” of a given display part relates to a region of the given display part that is employed for joining the given display part with another display part, external components, a display mounting arrangement, and the like. Optionally, the sealant area also allows for protecting the given display part by securing the periphery of the given display part. Notably the sealant areas of the first and second display parts are devoid of pixels and therefore, do not provide rendering functionality. Furthermore, optionally, a size of the sealant areas of the first and second display parts are smaller than a size of the display areas of the first and second display parts respectively. It will be appreciated that width (namely, thickness) of the sealant areas are dependent upon manufacturing techniques that are employed whilst manufacturing the first and second display parts. In an example, a width of the sealant areas of the first and second display parts is equal to 1 millimetre.

The second display resolution (of the second display part) is higher than the first display resolution (of the first display part). Throughout the present disclosure, the term “display resolution” of a given display part relates to pixel density (namely, pixels per unit area) within the display area of the given display part. In other words, the display resolution relates to a number of distinct pixels in each dimension that can be displayed. The second display resolution and the first display resolution are the maximum resolutions (namely, pixel densities) that are supported by the second display part and the first display part, respectively. Therefore, the first display part displays the first image at the first display resolution whereas the second display part displays the second image at the second display resolution. It will be appreciated that the second display resolution is higher than the first display resolution since the second image is to be typically projected (namely, directed) by the display apparatus on and around the fovea of the user's eyes, whereas the first image is to be projected (namely, directed) by the display apparatus upon a remaining region of the retina of the user's eyes. Typically, the user directs his/her gaze substantially towards the central region of the input image, which is depicted by way of the second image that is displayed at the second display part. Therefore, such display resolutions of the second display part and first display part allow for emulating visual characteristics of the human visual system when the input image depicting the visual scene is viewed by the user of the display apparatus.

Optionally, an angular resolution of the first display part is greater than 30 sec of arc. In an embodiment, the angular resolution of the first display part lies between 60 sec of arc and 300 sec of arc. In some implementations, the angular resolution of the first display part may be, for example, 60, 70, 80, 90, 100, 120, 140, 160, 180, 200, 22, 240, 260, 280 or 300 sec of arc. In another embodiment, the angular resolution of the first display part lies between 30 sec of arc and 60 sec of arc. Therefore, in some implementations, the angular resolution of the first display part may be, for example, 30, 35, 40, 45, 50, 55 or 60 sec of arc.

Optionally, an angular resolution of the second display part is lesser than 30 sec of arc. In some implementations, the angular resolution of the second display part may be, for example, 5, 10, 15, 20, 25 or 30 sec of arc.

In an example implementation, the second display part can be accommodated within (namely, inside) first display part. In such a case, the first display part may have an opening (namely, a cavity) in its central region and the second display part may have dimensions substantially similar (namely, equal) to or smaller than dimensions of the opening in the central region of the first display part. Therefore, the second display part may be placed inside the aforesaid opening of the first display part.

In another example implementation, the second display part may be placed behind the opening of the first display part. In such a case, the second display part may have dimensions substantially equal to or larger than the dimensions of the opening in the central region of the first display part. Alternatively, in such a case, the second display part could have dimensions smaller than the dimensions of the opening in the central region of the first display part.

In yet another example implementation, the second display part may be placed in front of the first display part. In such a case, the first display part is substantially continuous and may not have an opening in its central region. The second display part could be placed in front of the central region of the first display part.

In still another example implementation, the second display part may be placed upon the central region of the first display part.

It will be appreciated that the first display part and second display part collectively constitute the display of the aforesaid display apparatus to display the image depicting the visual scene thereupon.

It will be appreciated that the first display part is in the periphery of the second display part in a manner that the second display part covers a substantially larger area of the display as compared to the first display part. Optionally, the display area of the second display part is substantially larger than the display area of the first display part. In such a case, the second display part corresponds to a larger and a central portion of the display as compared to the first display part that corresponds to only a peripheral portion of the display. When such a display apparatus is employed to render the input image depicting the visual scene, the second image corresponding to a larger portion of the input image (namely, the second portion) can be depicted at the second display resolution, thereby, enhancing the user's perceived resolution of the input image. As an example, a diagonal length of the first display part may be 3.8 inches whereas a diagonal length of the second display part may be 1.5 inches.

Optionally, the first display part and/or the second display part are implemented by way of: a Liquid Crystal Display (LCD), a Light Emitting Diode (LED)-based display, an Organic LED (OLED)-based display, a micro OLED-based display, and a Liquid Crystal on Silicon (LCoS)-based display.

In the display apparatus, the processor is coupled to the display. In an embodiment, the processor is implemented by way of hardware, software, firmware or a combination of these, suitable for controlling the operation of the display apparatus. Notably, the processor is configured to control the operation of the display apparatus to render the input image depicting the visual scene to the user, when the user uses the display apparatus.

The processor is configured to render the first image and the second image at the first display part and the second display part, respectively and substantially simultaneously. It will be appreciated that the first and second images collectively constitute the input image depicting visual scene upon optical combination thereof. Furthermore, rendering the first and second images substantially simultaneously allows for rendering the input image as a whole, in a manner that the user views the complete visual scene at a given time instant, rather than as two separate parts at different time instants.

Optionally, the display further comprises at least a first optical piece and a second optical piece, the first optical piece being arranged over the display area of the first display part, the second optical piece being arranged over the display area of the second display part, wherein the first optical piece and the second optical piece are to be arranged for projecting images rendered at the first display part and the second display part onto a substantially continuous optical plane. Throughout the present disclosure, the term “optical piece” used herein relates to equipment for directing light emanating from the images (notably, the first and second images) rendered at the display areas of the first and the second display parts onto the substantially continuous optical plane. Notably, at least the first optical piece and the second optical piece are arranged over the display areas of the first display part and the second display part in a manner that the first and second images appear to be in the substantially continuous optical plane. It will be appreciated that the display apparatus could comprise more optical pieces, for example, such as a third optical piece, wherein all the optical pieces are arranged over the display areas of the first and second display parts in a manner that the images rendered at the first and second display parts are projected onto the substantially continuous optical plane.

Furthermore, it will be appreciated that the substantially continuous optical plane allows for input image (and consequently, the visual scene) constituted by the first and second images to appear uniform. Beneficially, when the input image is formed at the substantially continuous optical plane, a design of focusing optics that may be employed within the display apparatus to direct a projection of the input image towards the user's eyes, is substantially simple.

Optionally, the substantially continuous optical plane is flat. In such a case, the displayed input image appears to lie in a substantially-flat optical plane, when viewed from a perspective of the user's eyes. In such a case, irrespective of an actual physical arrangement of the first and second display parts, the first and second optical pieces allow for the first and second images to collectively constitute the input image in a continuous, flat optical plane.

Optionally, the substantially continuous optical plane is curved. In such a case, the displayed input image appears to lie in a substantially-curved optical plane, when viewed from the perspective of the user's eyes. In such a case, irrespective of an actual physical arrangement of the first and second display parts, the first and second optical pieces allow for the first and second images to collectively constitute the input image in a continuous, curved optical plane. It will be appreciated that a curved, substantially continuous optical plane beneficially displays the input image in a manner that the user experiences significant immersion within the visual scene, due to a corresponding curvature of his/her eyes.

Optionally, the first optical piece and the second optical piece are configured to guide light emanating from the first display part and the second display part in operation, respectively, in a manner that gaps between the display area of the first display part and the display area of the second display part are not perceptible to the user. Notably, the light emanating from the first display part corresponds to a projection of the displayed first image and the light emanating from the second part corresponds to a projection of the displayed second image. When the first and second display parts are arranged to form the display, the sealant areas on the first and second display parts form physical gaps between the display areas of the first and second display parts. If the first and second images are displayed upon the display areas of the first and second display parts having the aforesaid gaps, without employing the first and second optical pieces, the input image would appear discontinuous since the gaps would be visible to the user. Therefore, it will be appreciated that by way of guiding light emanating from the aforesaid display areas across such gaps, the first and second optical pieces allow for the gaps between the display area of the first display part and the display area of the second display part to be imperceptible to the user. Specifically, using the first optical piece and the second optical piece in the aforesaid manner allows for ‘shifting’ the display areas of the first display part and the second display part close to each other. As a result, the first and second images displayed upon the display areas of the first and second display parts, appears continuous, even when such display areas are physically spaced apart from each other.

Optionally, the first optical piece and/or the second optical piece are configured to guide light emanating from the first display part and/or the second display part in a substantially perpendicular direction of the display. As an example, the first optical piece and/or the second optical piece may be configured to guide light in the aforesaid manner when (i) the first display part has the opening therein and the second display part is arranged within or behind the opening, the dimensions of the second display part being substantially similar to the dimensions of the opening, (ii) the second display part is placed in front of the first display part, or (iii) the second display part is placed upon the central region of the first display part.

Optionally, the first optical piece is configured to guide the light emanating from the first display part towards a center of the display. In other words, the first optical piece is configured to guide the light emanating from the first display part towards the second display part. Such a manner of guiding light allows for the first optical piece to substantially conceal the gaps (namely, the sealant areas) between the first display part and the second display part. As an example, the first optical piece may be configured to guide light in the aforesaid manner when (i) the second display part is placed upon the central region of the first display part, (ii) the second display part is placed in front of the first display part, or (iii) the second display part is placed behind or arranged within the opening of the first display part, the dimensions of the second display part being smaller than the dimensions of the opening.

Optionally, the second optical piece is configured to guide the light emanating from the second display part towards a periphery of the display. In other words, the second optical piece is configured to guide the light emanating from the second display part towards the first display part. Such a manner of guiding light allows for the second optical piece to substantially conceal the gaps (namely, the sealant areas) between the first display part and the second display part. As an example, the second optical piece may be configured to guide light in the aforesaid manner when (i) the second display part is placed upon the central region of the first display part, (ii) the second display part is placed in front of the first display part, or (iii) the second display part is placed behind or arranged within the opening of the first display part, the dimensions of the second display part being smaller than the dimensions of the opening.

Optionally, the first optical piece is configured to guide the light emanating from the first display part towards the center of the display and the second optical piece is configured to guide the light emanating from the second display part towards the periphery of the display.

Optionally, the first optical piece and/or the second optical piece comprise a plurality of optical elements, wherein a given optical element comprises a plurality of optical fibers disposed within a substrate according to a predefined alignment. In such an instance, a given optical piece is a complex optical component, and is made up of the plurality of optical elements. It will be appreciated that when the given optical piece is complex and is made from several small optical elements, the aforesaid optical elements are arranged to be in contact with each other in a manner that the user is unable to detect boundaries of the optical elements.

Optionally, a given optical element is a section of a fiber optic plate that has been cut at a predefined angle. As an example, the predefined angle may be, 10 degrees, 30 degrees, 45 degrees, 60 degrees, 90 degrees, and so forth.

Optionally, a given optical element is implemented by way of any of: a convex lens, a plano-convex rod lens, a plano-concave rod lens, an aspheric photo lens, a ball lens, Gradient-index rod lens.

In an example, both the first optical piece and the second optical piece may be configured to guide the light emanating from the first display part and the second display part in the substantially perpendicular direction of the display. In such an example, both the first and the second optical pieces could comprise multiple optical elements that comprise the plurality of optical fibers disposed within the substrate, the plurality of optical fibers being aligned substantially perpendicular to a surface of the first and second display parts. In such an example, the substantially continuous optical plane may be flat.

In another example, the first optical piece may be configured to guide the light emanating from the first display part towards the center of the display, and the second optical piece may be configured to guide the light emanating from the second display part towards the substantially perpendicular direction of the display. In such an example, the first optical piece may comprise multiple optical elements, wherein a given optical element comprises the plurality of optical fibers disposed within the substrate at an angle of 45 degrees with respect to the surface of the first display part. Furthermore, in such an example, the second optical piece may comprise only a single optical element having optical fibers that are aligned substantially perpendicular to the surface of the second display part. In such an example, the substantially continuous optical plane may be curved.

Optionally, the first display part comprises a plurality of display elements, the plurality of display elements being arranged in a manner that borders of adjacent display elements are sealed together to form the first display part, and wherein the first optical piece comprises a plurality of optical elements, the plurality of optical elements being arranged to guide light emanating from the plurality of display elements in operation, in a manner that gaps between display areas of the adjacent display elements are not perceptible to a user. Such an implementation of the first display part may be employed when a size of the first display part is substantially large. In such a case, the plurality of display elements are joined by sealing the borders of the adjacent display elements, to form the first display part. Notably, the gaps between display areas of adjacent display elements correspond to widths of sealant areas of the adjacent display elements. Therefore, in such a case, the plurality of optical elements of the first optical piece are configured to guide light from the plurality of display elements in a manner that display areas of the plurality of display elements appear substantially close to each other, thereby, forming a continuous display area of the first display part.

Optionally, the plurality of display elements are implemented by way of: Liquid Crystal Displays (LCD), Light Emitting Diode (LED)-based displays, Organic LED (OLED)-based displays, micro OLED-based displays, and Liquid Crystal on Silicon (LCoS)-based displays.

Optionally, the display further comprises at least one magnifying optical element, the at least one magnifying optical element being arranged to magnify pixels at a periphery of the second display part to a size that is larger than an original size of the pixels, thereby enabling a smooth transition from the second display resolution to the first display resolution. The pixels at the periphery of the second display part substantially correspond to pixels along a border of the display area of the second display part and the sealant area of the second display part. When such pixels are magnified to a size that is larger than the original size thereof, such pixels provide a third display resolution, the third display resolution being greater than the first display resolution but lesser than the second display resolution. Therefore, in such a case, the user is able to perceive a gradual transition of the input image from the first display resolution to the second display resolution, thereby allowing the image to appear smooth. Furthermore, since the aforesaid pixels appear magnified, a portion of the second image displayed thereupon also appears enlarged, thereby, substantially hiding (namely, masking or obscuring) the gaps between the display area of the first display part and the display area of the second display part, in a manner that such gaps are imperceptible to the user. Examples of the at least one magnifying optical element include, but are not limited to, a convex lens and a plano-convex lens.

Furthermore, optionally, the processor may be configured to digitally magnify pixels at a periphery of the second display part to a size that is larger than the original size of the pixels via at least one image processing algorithm.

Optionally, the display apparatus further comprises means for tracking a head orientation of the user, wherein the head orientation is to be tracked when the display apparatus in operation is worn by the user, the processor being coupled to said means, the processor being at least communicably coupled to an imaging system, wherein the processor is configured to:

(a) communicate, to the imaging system, information indicative of a current head orientation of the user;
(b) obtain, from the imaging system, an image of a given real-world environment, wherein the image is to be captured by the imaging system based upon the current head orientation of the user; and
(c) process the image of the given real-world environment to generate the first image and the second image to be rendered at the first display part and the second display part, respectively.

Throughout, the present disclosure, the term “means for tracking a head orientation” used herein relates to specialized equipment for detecting and optionally, following the direction of the user's head, when the display apparatus is worn by the user. It will be appreciated that the orientation of user's head user may be substantially straight, substantially sideways, substantially upwards, substantially downwards, or any combination thereof. Beneficially, an accurate detection of the user's head orientation facilitates the display apparatus to closely implement gaze contingency thereon by way of adjusting the visual scene according to the gaze direction of the user. The processor is configured to receive, from said means, information indicative of the current head orientation of the user. In such an instance, the orientation of the at least one imaging system is adjusted to allow for capturing the image of the given real-world environment, from a perspective of the head orientation of the user. Thereafter, the captured image of the given real-world scene acts as the input image, and is processed to generate the first image and the second image. Examples of the means for tracking the head orientation of the user include, but are not limited to, a gyroscope, and an accelerometer.

Throughout the present disclosure, the term “imaging system” used herein relates to equipment configured to capture the image of the given real-world scene, that is to be displayed to the user via the display apparatus. It will be appreciated that the image captured by the imaging system, is employed to present the visual scene of the simulated environment (for example, such as a virtual reality environment, an augmented reality environment, and so forth) to the user of the display apparatus, when the display apparatus is worn by the user.

It will be appreciated that tracking of the head orientation of the user, obtaining of the captured image of the given real-world environment, communication of the captured image from the imaging system to the processor, processing of the captured image to generate the first and second images, and display of the first and second images at the first display part and the second display part, occur substantially simultaneously. Therefore, the user of the display apparatus is provided with a seamless experience of the visual scene.

In one implementation, the imaging system is to be integrated with the display apparatus. In such an instance, the imaging system is implemented on (namely, mounted on) the display apparatus. Furthermore, in this regard, at least one camera may be mounted, for example, on an outer surface of the display apparatus, such that the camera faces the given real-world environment. Therefore, in operation, the at least one camera is configured to capture an image of the given real-world environment whereat the user is physically present. When the user moves his/her head, the orientation of the imaging system integrated with the display apparatus changes automatically, to capture the image of the given real-world environment, based upon the current head orientation of the user.

In another implementation, the imaging system is to be integrated with a remote device. In such an instance, the at last one camera is mounted on the remote device, and are therefore external to the display apparatus. Furthermore, in such an implementation, the remote device may be positioned within the given real-world environment whereas the user of the display apparatus may be positioned away from (namely, at a distance from) the remote device. When the user moves his/her head, the orientation of the imaging system integrated with the remote device is changed (for example, by way of actuators), to capture the image of the given real-world environment, based upon the current head orientation of the user. Optionally, the remote device is one of: a drone, a robot.

It will be appreciated that when the user turns his/her head, the user's view of the simulated environment changes substantially. Typically, users are known to have a tendency of gazing towards a central portion of a given visual scene. In such a case, when the user wishes to view a peripheral portion of the given visual scene, he/she typically orients his/her head in a manner that the given visual scene changes to a next visual scene. Notably, the next visual scene depicts the aforesaid peripheral portion of the given visual scene, in a central portion thereof. In other words, upon change in the head orientation of the user, the peripheral portion of one visual scene would substantially become a central portion of another visual scene. Therefore, it will be appreciated that when the image of the given real-world environment (namely, the input image) is captured from the perspective of the head orientation of the user, the second image generated upon processing the captured image substantially corresponds to a region of the given real-world scene whereat the user's gaze is focused. Consequently, when such a region depicted by way of the second image is displayed at the second display part having the second display resolution, the display allows for emulating properties of the human visual system.

Optionally, the first image has a first resolution, while the second image has a second resolution, wherein the second resolution is higher than the first resolution.

Alternatively, optionally, both the first and second images have a substantially same resolution. In such a case, the difference in perceptible resolutions of the first and second images is due to different display resolutions of the first display part and the second display part of the display.

Optionally, the second image comprises a plurality of image segments having different resolutions, wherein the processor, when generating the second image at (c), is configured to gradually decrease the resolution of the plurality of image segments as a function of their distance from a center of the second image, wherein the center of the second image is to be rendered substantially at a center of the display. In such a case, the center of the display substantially corresponds to a center of the second display part. Notably, the plurality of image segments having different resolutions allow for enabling a smooth transition of perceptible resolution within the second image, and subsequently, from the second image to the first image. Specifically, the resolution of image segments substantially at the center of the image segments is higher than the resolution of image segments along the periphery of the second image. Optionally, the processor is configured to adjust the resolution of the plurality of image segments by way of adjusting magnification of pixels associated with the plurality of image segments. In other words, digital magnification of pixels associated with the plurality of image segments appears to gradually increase as a function of their distance from the center of the second image.

The present disclosure also relates to the display apparatus as described above. Various embodiments and variants disclosed above apply mutatis mutandis to the display apparatus.

Optionally, in the display apparatus, the display further comprises at least the first optical piece and the second optical piece, the first optical piece being arranged over the display area of the first display part, the second optical piece being arranged over the display area of the second display part, wherein the first optical piece and the second optical piece are to be arranged for projecting images rendered at the first display part and the second display part onto the substantially continuous optical plane.

Optionally, in the display apparatus, the substantially continuous optical plane is curved.

Optionally, in the display apparatus, the first optical piece and the second optical piece are configured to guide light emanating from the first display part and the second display part in operation, respectively, in the manner that gaps between the display area of the first display part and the display area of the second display part are not perceptible to the user.

Optionally, in the display apparatus, the first optical piece is configured to guide the light emanating from the first display part towards the center of the display.

Optionally, in the display apparatus, the second optical piece is configured to guide the light emanating from the second display part towards the periphery of the display.

Optionally, in the display apparatus, the first optical piece and/or the second optical piece comprise the plurality of optical elements, wherein the given optical element comprises the plurality of optical fibers disposed within the substrate according to the predefined alignment.

Optionally, in the display apparatus, the first display part comprises the plurality of display elements, the plurality of display elements being arranged in the manner that borders of adjacent display elements are sealed together to form the first display part, and wherein the first optical piece comprises the plurality of optical elements, the plurality of optical elements being arranged to guide light emanating from the plurality of display elements in operation, in the manner that gaps between the display areas of the adjacent display elements are not perceptible to the user.

Optionally, in the display apparatus, the display further comprises the at least one magnifying optical element, the at least one magnifying optical element being arranged to magnify pixels at the periphery of the second display part to the size that is larger than the original size of the pixels, thereby enabling the smooth transition from the second display resolution to the first display resolution.

### DETAILED DESCRIPTION OF THE DRAWINGS

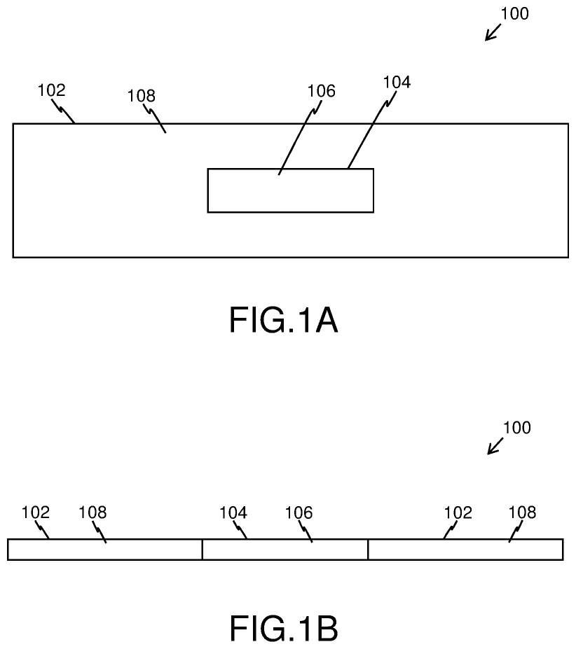

Referring to FIGS. 1A and 1B, illustrated is a front view and a top view of a display 100 for use in a display apparatus (not shown) respectively, in accordance with an embodiment of the present disclosure. It may be understood by a person skilled in the art that the FIGS. 1A and 1B include simplified views of the display 100 for sake of clarity only, which should not unduly limit the scope of the claims herein. The person skilled in the art will recognize many variations, alternatives, and modifications of embodiments of the present disclosure.

As shown in FIGS. 1A and 1B, the display 100 comprises a first display part 102 having a first display resolution, and a second display part 104 having a second display resolution, the second display resolution being higher than the first display resolution. The first display part 102 and the second display part 104 are arranged in a manner that a display area 106 of the second display part 104 is substantially surrounded by a display area 108 of the first display part 102.

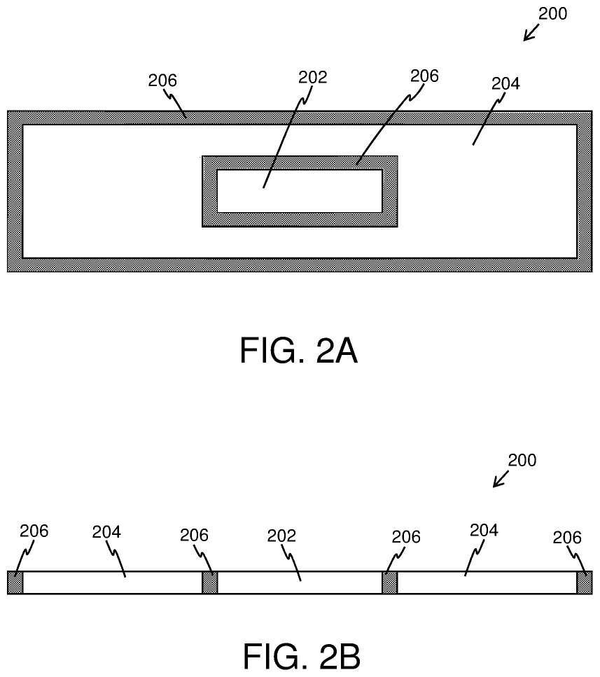

Referring to FIGS. 2A and 2B, illustrated is a front view and a top view of a first display part 200 of a display (for example, such as the first display part 102 of the display 100 of FIGS. 1A and 1B) respectively, in accordance with an embodiment of the present disclosure. It may be understood by a person skilled in the art that the FIGS. 2A and 2B include a simplified implementation of the first display part 200 for sake of clarity only, which should not unduly limit the scope of the claims herein. The person skilled in the art will recognize many variations, alternatives, and modifications of embodiments of the present disclosure.

As shown in FIGS. 2A and 2B, the first display part 200 having a first display resolution has an opening (namely, a cavity) 202 in its central region. The first display part 200 comprises a display area 204 that is surrounded with a sealant area 206. Furthermore, the sealant area 206 is present at an outer periphery and an inner periphery of the first display part 200.

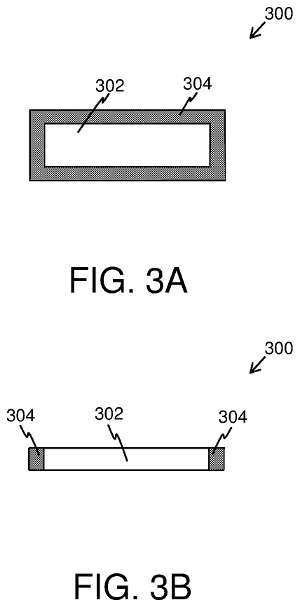

Referring to FIGS. 3A and 3B, illustrated is a front view and a top view of a second display part 300 of a display (for example, such as the second display part 104 of the display 100 of FIGS. 1A and 1B), in accordance with an embodiment of the present disclosure. It may be understood by a person skilled in the art that the FIGS. 3A and 3B include a simplified implementation of the second display part 300 of a display for sake of clarity, which should not unduly limit the scope of the claims herein. The person skilled in the art will recognize many variations, alternatives, and modifications of embodiments of the present disclosure.

As shown in FIGS. 3A and 3B, the second display part 300 having a second display resolution comprises a display area 302 surrounded with a sealant area 304.

In operation, a first display part (for example, such as the first display part 200 of FIGS. 2A and 2B) and the second display part 300 are arranged in a manner that the display area 302 of the second display part 300 is substantially surrounded by the display area 204 of the first display part 200, thereby constituting the display for use in a display apparatus.

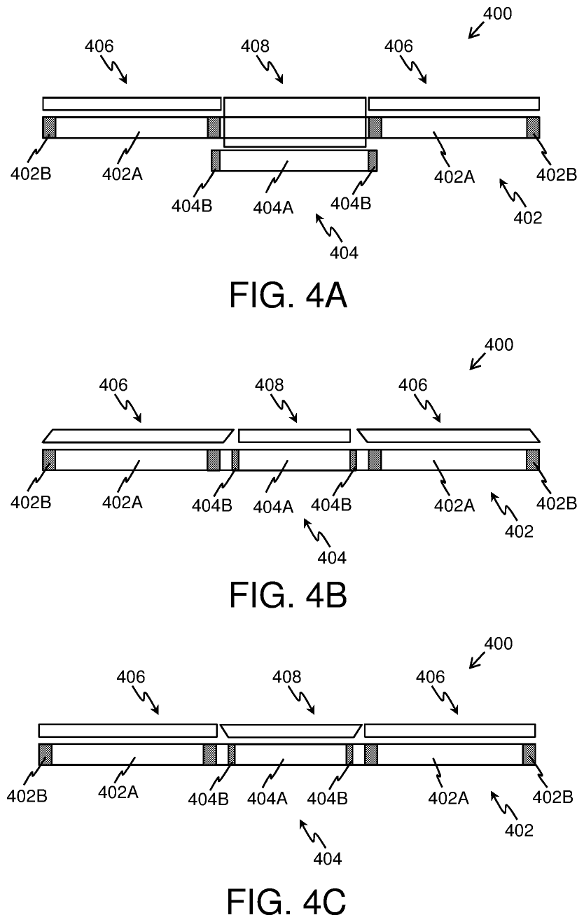

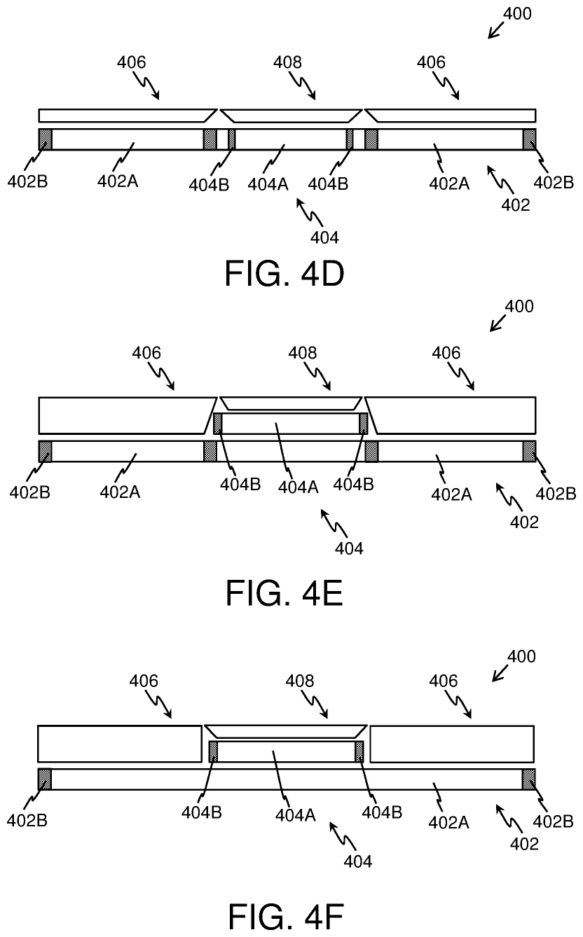

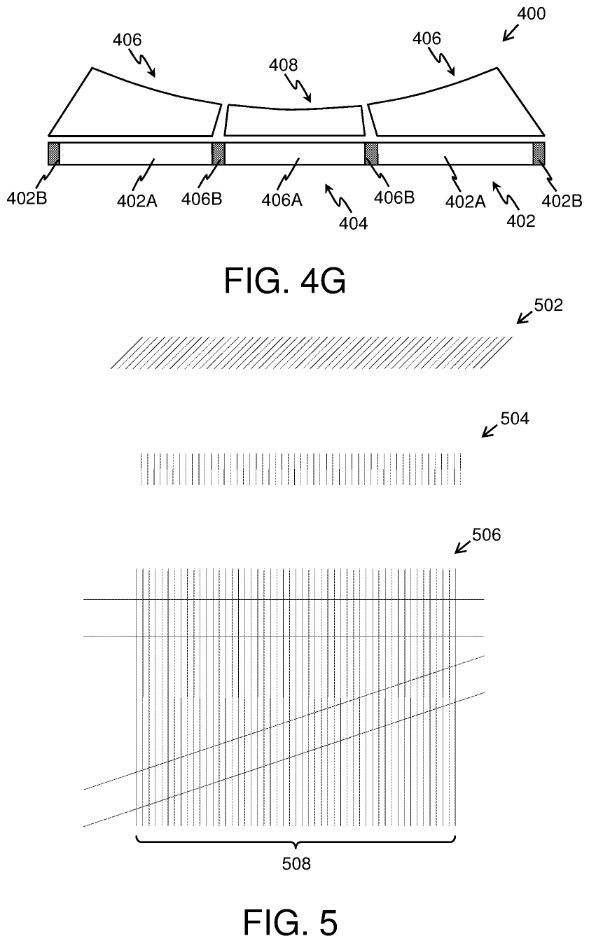

Referring to FIGS. 4A-4G, illustrated are exemplary implementations of a display 400, in accordance with various embodiments of the present disclosure. It may be understood by a person skilled in the art that the FIGS. 4A-4G include simplified arrangements for implementation of the display 400 for sake of clarity, which should not unduly limit the scope of the claims herein. The person skilled in the art will recognize many variations, alternatives, and modifications of embodiments of the present disclosure.

As shown in FIGS. 4A-4G, the display 400 comprises a first display part 402 having a first display resolution, and a second display part 404 having a second display resolution, the second display resolution being higher than the first display resolution. The first display part 402 and the second display part 404 are arranged in a manner that a display area 404A of the second display part 404 is substantially surrounded by a display area 402A of the first display part 402. Furthermore, as shown, the display area 402A of the first display part 402 is surrounded by a sealant area 402B and the display area 404A of the second display part 404 is surrounded by a sealant area 404B. The display 400 further comprises at least a first optical piece 406 and a second optical piece 408. The first optical piece 406 is arranged over the display area 402A of the first display part 402 and the second optical piece 408 is arranged over the display area 404A of the second display part 404, wherein the first optical piece 406 and the second optical piece 408 are to be arranged for projecting images rendered at the first display part 402 and the second display part 404 onto a substantially continuous optical plane.

In FIGS. 4A-4F, the substantially continuous optical plane is flat.

In FIG. 4G, the substantially continuous optical plane is curved.

In operation, the first optical piece 406 and the second optical piece 408 are configured to guide light emanating from the first display part 402 and the second display part 404 respectively, in a manner that gaps (notably, the sealant areas 402B and 404B) between the display area 402A of the first display part 402 and the display area 404A of the second display part 404 are not perceptible to a user.

As shown in FIG. 4A, the second display part 404 is placed behind an opening in the first display part 402.

As shown in FIGS. 4B, 4C, 4D and 4G, the second display part 404 is placed inside the opening of the first display part 402.

As shown in FIGS. 4E and 4F, the second display part 404 is placed over (namely, on top of) the first display part 402.

Referring to FIG. 5 is a schematic illustration of an exemplary first optical element 502 and an exemplary second optical element 504, in accordance with an embodiment of the present disclosure. The first optical element 502 and the second optical element 504 can be obtained from a fibre optic plate 506. As shown, the fibre optic plate 506 comprises a plurality of optical fibres 508 disposed within a substrate according to a predefined alignment. The fibre optic plate 506 can be cut at predefined angles to obtain the first optical element 502 and the second optical element 504. Therefore, the first optical element 502 and the second optical element 504 comprise the plurality of optical fibres 508 disposed within the substrate according to different alignments. For example, the fibre optic plate 506 can be cut at an angle of 60 degrees to obtain the first optical element 502 and at an angle of 90 degrees to obtain the second optical element 504.

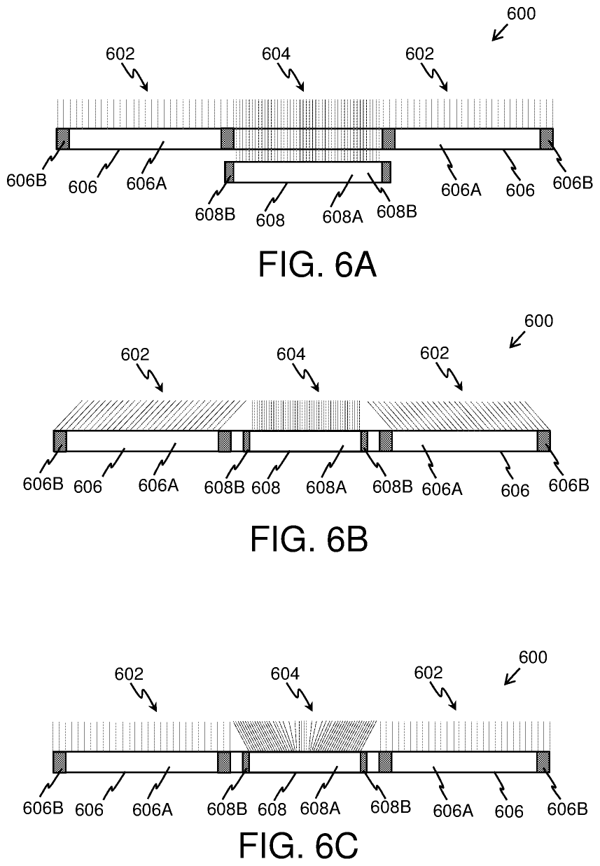

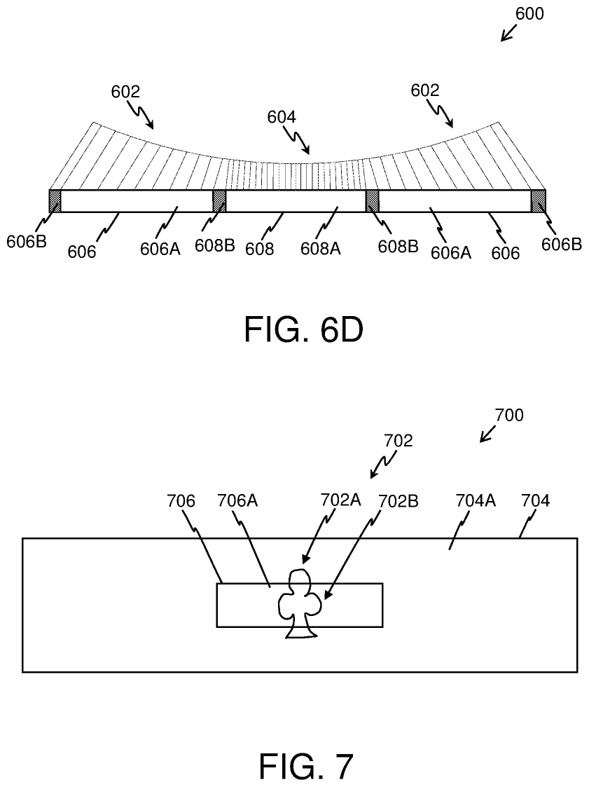

Referring to FIGS. 6A-6D, illustrated are exemplary implementations of a first optical piece 602 and a second optical piece 604 in a display 600, in accordance with various embodiments of the present disclosure. It may be understood by a person skilled in the art that the FIGS. 6A-6D include simplified arrangements for implementation of the first optical piece 602 and second optical piece 604 for sake of clarity only, which should not unduly limit the scope of the claims herein. The person skilled in the art will recognize many variations, alternatives, and modifications of embodiments of the present disclosure.

As shown in FIGS. 6A-6D, the display 600 comprises a first display part 606, and a second display part 608 being arranged in a manner that a display area 608A of the second display part 608 is substantially surrounded by a display area 606A of the first display part 606. Furthermore, as shown, the display area 606A of the first display part 606 is surrounded by a sealant area 606B and the display area 608A of the second display part 608 is surrounded by a sealant area 608B. The first optical piece 602 is arranged over the display area 606A of the first display part 606 and the second optical piece 604 is arranged over the display area 608A of the second display part 608, wherein the first optical piece 602 and the second optical piece 604 are to be arranged for projecting images rendered at the first display part 606 and the second display part 608 onto a substantially continuous optical plane. The first optical piece 602 and/or the second optical piece 604 comprise a plurality of optical elements, wherein a given optical element comprises a plurality of optical fibres disposed within a substrate according to a predefined alignment.

In FIG. 6A, the first optical piece 602 and the second optical piece 604 are configured to guide light emanating from the first display part 606 and the second display part 608 in a substantially perpendicular direction of the display 600.

In FIG. 6B, the second optical piece 604 is configured to guide light emanating from the second display part 608 in the substantially perpendicular direction of the display 600, and the first optical piece 602 is configured to guide light emanating from the first display part 606 towards a centre of the display 600.

In FIG. 6C, the second optical piece 604 is configured to guide light emanating from the second display part 608 towards a periphery of the display 600, and the first optical piece 602 is configured to guide light emanating from the first display part 606 in the substantially perpendicular direction of the display 600.

In FIG. 6D, the second optical piece 604 and the first optical piece 602 are configured to guide light emanating from the second display part 608 and the first display part 606 substantially towards a centre of the display 600. Furthermore, in FIG. 6D, the substantially continuous optical plane is curved.

Referring to FIG. 7 is a schematic illustration of an input image 702 displayed at a display 700, in accordance with an embodiment of the present disclosure. As shown, the input image 702 includes a first image 702A and a second image 702B, wherein the first image 702A is rendered at a display area 704A of a first display part 704 and the second image is rendered at a display area 706A of a second display part 706 of the display 700. A first optical piece (not shown) and a second optical piece (not shown) are arranged over the first display part 704 and the second display part 706 for projecting the first image 702A and the second image 702B at the first display part 704 and the second display part 706, respectively, onto a substantially continuous optical plane. Notably, the first optical piece and the second optical piece are configured to guide light emanating from the first display part 704 and the second display part 706 in operation, respectively, in a manner that gaps between the display area 704A of the first display part 704 and the display area 706A of the second display part are not perceptible to a user. As a result, the displayed input image 702 appears continuous to the user.

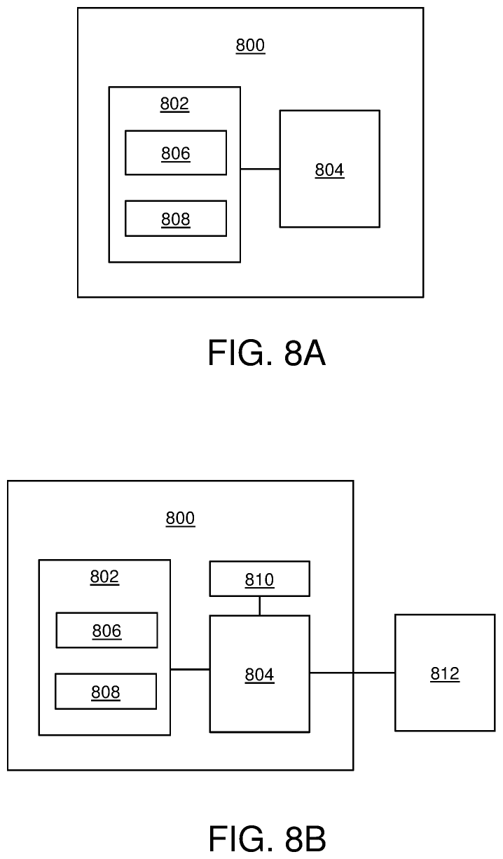

Referring to FIGS. 8A and 8B, illustrated are block diagrams of architecture of a display apparatus 800, in accordance with different embodiments of the present disclosure. It may be understood by a person skilled in the art that the FIGS. 8A and 8B include simplified arrangements for implementation of the display apparatus 800 for sake of clarity, which should not unduly limit the scope of the claims herein. The person skilled in the art will recognize many variations, alternatives, and modifications of embodiments of the present disclosure.

As shown in FIGS. 8A and 8B, the display apparatus 800 comprises a display 802, and a processor 804. The display 802 comprises a first display part 806 and a second display part 808, the first display part 806 having a first display resolution, the second display part 808 having a second display resolution, the second display resolution being higher than the first display resolution, the first display part 806 and the second display part 808 being arranged in a manner that a display area of the second display part is substantially surrounded by a display area of the first display part. The processor 804 is coupled to the display, wherein the processor 804 is configured to render a first image and a second image at the first display part 806 and the second display part 808, respectively and substantially simultaneously.

In FIG. 8B, the display apparatus 800 further comprises means 810 for tracking head orientation of a user, wherein the head orientation is to be tracked when the display apparatus 800 in operation is worn by the user. The processor 804 is communicably coupled to the said means 810 and an imaging system 812. In operation, the processor 804 is configured to (a) communicate, to the imaging system 812, information indicative of a current head orientation of the user; (b) obtain, from the imaging system 812, an image of a given real-world environment, wherein the image is to be captured by the imaging system 812 based upon the current head orientation of the user; and (c) process the image of the given real-world environment to generate the first image and the second image to be rendered at the first display part 806 and the second display part 808, respectively.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A display for use in a display apparatus, the display comprising:
a first display part having a first display resolution; and
a second display part having a second display resolution, the second display resolution being higher than the first display resolution, the first display part and the second display part being arranged in a manner that a display area of the second display part is substantially surrounded by a display area of the first display part.

2. The display of claim 1, further comprising at least a first optical piece and a second optical piece, the first optical piece being arranged over the display area of the first display part, the second optical piece being arranged over the display area of the second display part, wherein the first optical piece and the second optical piece are to be arranged for projecting images rendered at the first display part and the second display part onto a substantially continuous optical plane.

3. The display of claim 2, wherein the substantially continuous optical plane is curved.

4. The display of claim 2, wherein the first optical piece and the second optical piece are configured to guide light emanating from the first display part and the second display part in operation, respectively, in a manner that gaps between the display area of the first display part and the display area of the second display part are not perceptible to a user.

5. The display of claim 4, wherein the first optical piece is configured to guide the light emanating from the first display part towards a centre of the display.

6. The display of claim 4, wherein the second optical piece is configured to guide the light emanating from the second display part towards a periphery of the display.

7. The display of claim 2, wherein the first optical piece and/or the second optical piece comprise a plurality of optical elements, wherein a given optical element comprises a plurality of optical fibers disposed within a substrate according to a predefined alignment.

8. The display of claim 2, wherein the first display part comprises a plurality of display elements, the plurality of display elements being arranged in a manner that borders of adjacent display elements are sealed together to form the first display part, and wherein the first optical piece comprises a plurality of optical elements, the plurality of optical elements being arranged to guide light emanating from the plurality of display elements in operation, in a manner that gaps between display areas of the adjacent display elements are not perceptible to a user.

9. The display of claim 1, further comprising at least one magnifying optical element, the at least one magnifying optical element being arranged to magnify pixels at a periphery of the second display part to a size that is larger than an original size of the pixels, thereby enabling a smooth transition from the second display resolution to the first display resolution.

10. A display apparatus comprising:
a display comprising a first display part and a second display part, the first display part having a first display resolution, the second display part having a second display resolution, the second display resolution being higher than the first display resolution, the first display part and the second display part being arranged in a manner that a display area of the second display part is substantially surrounded by a display area of the first display part; and
a processor coupled to the display, the processor being configured to render a first image and a second image at the first display part and the second display part, respectively and substantially simultaneously.

11. The display apparatus of claim 10, further comprising means for tracking a head orientation of a user, wherein the head orientation is to be tracked when the display apparatus in operation is worn by the user, the processor being coupled to said means, the processor being at least communicably coupled to an imaging system, wherein the processor is configured to:
(a) communicate, to the imaging system, information indicative of a current head orientation of the user;
(b) obtain, from the imaging system, an image of a given real-world environment, wherein the image is to be captured by the imaging system based upon the current head orientation of the user; and
(c) process the image of the given real-world environment to generate the first image and the second image to be rendered at the first display part and the second display part, respectively.

12. The display apparatus of claim 11, wherein the second image comprises a plurality of image segments having different resolutions, wherein the processor, when generating the second image at (c), is configured to gradually decrease the resolution of the plurality of image segments as a function of their distance from a centre of the second image, wherein the centre of the second image is to be rendered substantially at a centre of the display.

13. The display apparatus of claim 10, wherein the display further comprises at least a first optical piece and a second optical piece, the first optical piece being arranged over the display area of the first display part, the second optical piece being arranged over the display area of the second display part, wherein the first optical piece and the second optical piece are to be arranged for projecting images rendered at the first display part and the second display part onto a substantially continuous optical plane.

14. The display apparatus of claim 13, wherein the substantially continuous optical plane is curved.

15. The display apparatus of claim 13, wherein the first optical piece and the second optical piece are configured to guide light emanating from the first display part and the second display part in operation, respectively, in a manner that gaps between the display area of the first display part and the display area of the second display part are not perceptible to a user.

16. The display apparatus of claim 15, wherein the first optical piece is configured to guide the light emanating from the first display part towards a centre of the display.

17. The display apparatus of claim 15, wherein the second optical piece is configured to guide the light emanating from the second display part towards a periphery of the display.

18. The display apparatus of claim 13, wherein the first optical piece and/or the second optical piece comprise a plurality of optical elements, wherein a given optical element comprises a plurality of optical fibres disposed within a substrate according to a predefined alignment.

19. The display apparatus of claim 13, wherein the first display part comprises a plurality of display elements, the plurality of display elements being arranged in a manner that borders of adjacent display elements are sealed together to form the first display part, and wherein the first optical piece comprises a plurality of optical elements, the plurality of optical elements being arranged to guide light emanating from the plurality of display elements in operation, in a manner that gaps between display areas of the adjacent display elements are not perceptible to a user.

20. The display apparatus of claim 10, wherein the display further comprises at least one magnifying optical element, the at least one magnifying optical element being arranged to magnify pixels at a periphery of the second display part to a size that is larger than an original size of the pixels, thereby enabling a smooth transition from the second display resolution to the first display resolution.
